(19) United States
(12) Patent Application Publication
(10) Pub. No.: US 2012/0111583 A1
(43) Pub. Date: May 10, 2012

(54) STONE DUSTING

(75) Inventors: Alan Graham Brown, Victoria (AU); Carlos Alberto Mari, Victoria (AU); Rodney James Connell, Western Australia (AU); Matthew Charles Ryan, Queensland (AU)

(73) Assignees: Mining Attachments (QLD) Pty Ltd., Queensland (AU); Applied Australia Pty Ltd., Victoria (AU)

(21) Appl. No.: 13/133,282

(22) PCT Filed: Jun. 1, 2009
(86) PCT No.: PCT/AU2009/000688

§ 371 Date: Oct. 27, 2011

(30) Foreign Application Priority Data
Dec. 8, 2008 (AU) 2008906340

(51) Int. Cl. A62C 3/00; A62D 1/06; C09K 3/00

(52) U.S. Cl. 169/45; 252/382; 252/7

(57) ABSTRACT

The invention relates to a method of dusting coal mine surfaces, the method comprising applying stone dust particles treated with a cationic and/or zwitterionic surfactant to surfaces in the coal mine. The invention also relates to liquid formulations, coal mine dusting agents and apparatus for use in such a method.

### FIELD OF THE INVENTION

The present invention relates to stone dusting in, for example, coal mines. In one embodiment, the invention relates to methods for dusting coal mine surfaces, treatment of the stone dust particles prior to using the particles in the dusting process and to apparatus that can be used to apply the stone dust particles to surfaces.

### BACKGROUND

Underground coal mines experience a major hazard during seismic events because coal dust naturally present in the mine is disturbed and suspended in the air. In the event of an explosion, the coal/air mix acts as a conduit for the explosive flame to travel along the mine tunnels.

To reduce the formation of the coal/air mix and inhibit flame propagation, most coal mine operations apply stone dust particles, such as calcium carbonate powder, to walls in a dry process. Any explosion or seismic event will create shock waves that disturb the applied calcium carbonate and cause a mixture of coal and calcium carbonate dust to be suspended in the air. Heat from the flame propagation of the explosion can break down the calcium carbonate to form carbon dioxide, which quenches the flame.

One of the major limitations of stone dust used in underground coal mines is the interruption to production necessitated by the requirement to apply the stone dust particles to intake airways. Typically, stone dust particles are applied by some means of blowing the dust onto the roadway surfaces which leads to the generation of large quantities of fugitive dust and contamination of the downstream airflow. This contamination requires that personnel are removed from inbye of the stone dusting position and stone dusting of intake roadways can only be done when there is a significant break in mining production. The closure of a mine is costly in terms of lost production time.

Attempts have been made to address these shortcomings with the development in the last decade of wet stone dusting. In wet dusting, dry stone dust particles are mixed with a quantity of water in an agitator and spayed as a slurry on to the coal mine surfaces. The wet method eliminates the problem of contamination of the airflow, but brings with it a new problem. As the water-stone dust slurry dries out on the mine surfaces it hardens to form a caked layer, not a friable powder coating. It is strongly suspected that this caked layer compromises the dispersal characteristics of the stone dust particles and therefore their ability to suppress a coal dust explosion. It is believed that subsequent roadway dust deposits could be lifted in an explosion without disturbance of the caked stone dust particles negating the intend effect of the stone dusting.

As a result of these concerns, the use of wet stone dusting processes are restricted in many countries. In some countries, wet stone dust cannot be used without augmentation by conventional dry stone dusting or regular re-applications of the wet stone dust. Accordingly, many coal mines are currently operating using the dry dusting process, which has the associated disadvantages discussed above.

Accordingly, there is a need for an improved stone dusting process that does not suffer from the disadvantages of the dry dusting process, but which provides a coating on a surface that is at least as dispersible as the applied dry dust particles. Once this process has been developed for use in coal mines, the same process could be applied to other confined spaces in which disturbed dust presents a flammable hazard.

### SUMMARY OF THE INVENTION

According to a first aspect of the invention, there is provided a method of dusting coal mine surfaces, the method comprising applying stone dust particles treated with a cationic and/or zwitterionic surfactant to surfaces in the coal mine.

The treatment of the stone dust particles with a cationic and/or zwitterionic surfactant is thought to inhibit caking in the applied stone dust coating. The prevention or decrease in the amount of caking is believed to result in a friable coating from which stone dust particles can be disturbed and carried into the air. Accordingly, the suspended stone dust particles are able to inhibit flame propagation.

It is thought that treatment with the surfactant provides a dispersible powder coating because the surface charge of the dust particle surface is opposite to the charge on the surfactant's polar head. This causes the surfactant to absorb onto the surface of the stone dust particle with the hydrophobic tail of the surfactant directed away from the surface. The hydrophobic tail of the surfactant is believed to function as steric hindrance, preventing individual dust particles from coming into contact with one another and hence reducing the ability of adjacent particles to form salt bridging that could result in caking.

It is also likely that the absorption and neutralisation of surface charge by the adsorbed surfactant reduces static attractions between stone dust particles. Furthermore, the hydrophobic layer formed by the surfactant tail is thought to act as a ‘lubricant’ that permits stone dust particles to slide over one another. All of these effects substantially reduce the tendency for the stone dust particles in the coating applied to the coal mine surface to cake. Accordingly, any stone dust particles applied to the mine surfaces remain in a dispersible form.

It is known that as the particle size of stone dust increases, the particles become less effective at inhibiting a coal dust explosion. Accordingly, particles used in dusting must meet the guidelines set out in ‘Guidelines for Coal Dust Explosion, Prevention and Suppression’ publication MDG3006 MRT5, published by the NSW Department of Mineral Resources.

In some embodiments, the coating results in the dispersal of particles within the Guidelines. In summary, the Guidelines require that:
(i) not less than 95% by mass of the stone dust particles must pass through a 250 micrometre sieve, and
(ii) of the dry stone dust particles which pass through a 250 micrometre sieve not less than 60% and not more than 80% by mass must pass through a 75 micrometre sieve.

In one embodiment, the method further includes the step of mixing the stone dust particles with a solution comprising the cationic and/or zwitterionic surfactant to thereby treat the particles. As mentioned above, the treatment promotes steric hindrance between particles and/or inhibits salt bridge formation or caking once the stone dust particles are applied to the coal mine surfaces. The treatment provides a coating on the surfaces that is dispersible upon agitation.

According to a second aspect of the invention there is provided a formulation when used to treat stone dust particles applied to coal mine surfaces, the formulation comprising a cationic and/or zwitterionic surfactant.

There may be more than one cationic surfactant and/or more than one zwitterionic surfactant in the formulation used to treat the stone dust particles. References in this specification to surfactant in the singular should be understood to include a plurality of surfactants, unless the context makes clear otherwise.

In another aspect, the invention provides a coal mine dusting agent comprising stone dust particles treated with a cationic and/or zwitterionic surfactant. The coal mine dusting agent can be applied to surfaces in the coal mine as a dry powder or in a wet slurry. In either case, the resulting surface coating comprises dispersible stone dust particles that inhibit flame propagation in the coal mine.

The surfactant chosen for use in the invention should be soluble in the formulation. Since water is the preferred solvent preferably the surfactant is water soluble. The surfactant should be stable in the presence of any dissolved ions present in the mine water supply. Preferably, the surfactant is environmentally friendly and presents minimum occupational health and safety issues for personnel.

Cationic surfactants have a formal positive charge. Zwitterionic surfactants are capable of exhibiting a positive and/or a negative charge. There are zwitterionics that maintain both a positive and a negative charge independent of pH and others in which the overall charge varies with pH. The preferred zwitterionic surfactants are those that can assume a charge opposite to the charge present on the stone dust particle surface. For example, if the stone dust particle surface is negatively charged, when in close proximity, the zwitterionic surfactant molecule will assume a net positive charge. In some embodiments, a blend of cationic and zwitterionic surfactants can be used.

In some embodiments, in addition to surfactant, a foaming agent can be added to the slurry. The surfactant itself can be the foaming agent. The slurry can be applied to the surfaces of the coal mine as a foam to provide the coating.

In yet another aspect there is provided an apparatus to apply a foamed slurry comprising stone dust particles to the surfaces of a coal mine, the apparatus comprising:
a mixing vessel in which stone dust particles are mixed with a liquid to form a slurry; and
an applicator connected to said mixing vessel for application of the slurry to the coal mine surfaces, said applicator comprising an aerator for foaming the slurry as it is applied;
wherein said stone dust particles are treated with a cationic and/or zwitterionic surfactant prior to application to the coal mine surfaces.

In another aspect of the invention there is provided the apparatus described in the immediately preceding paragraph when used to apply the foamed slurry.

### DESCRIPTION OF PREFERRED EMBODIMENTS OF THE INVENTION

The present invention is described in terms of dusting of surfaces in mines for mining coal. These mines require dusting because the resource extracted from the earth i.e. coal, is combustible. However, the invention is not so limited and the treated dust particles can be applied to other confined spaces in which dusts are able to disperse in air and generate a flammable suspension.

The surfaces that can be dusted in the mine are not restricted and any exposed surface can have a coating of stone dust particles applied thereon. The skilled addressee will understand which surfaces in the mine require dusting.

The stone dust particles used in the process of the present invention can be any particles that are dusted onto coal mine surfaces to inhibit flame propagation during a seismic event. The dust particles could comprise dolomite, magnesite, fly ash, silica fume, gypsum, anhydrite, non-expansive clays or fine ground mine tailings or any mixtures thereof. However, in a preferred embodiment, the stone dust particles comprise at least some particles of a carbonate compound. Preferably, the carbonate compound is calcium carbonate. Carbonate-containing particles are preferred because, upon heating, the carbonate forms carbon dioxide which acts to quench any flame in the same way as a traditional fire extinguisher. The non-carbonate dusts simply work by diluting the coal dust suspended in air.

In some embodiments at least 10%, more preferably at least 50% of the stone dust particles comprise a carbonate compound capable of releasing carbon dioxide with the remainder of the stone dust particles being incapable of releasing carbon dioxide, e.g. magnesite. It should be understood that in some embodiments, 100% of the particles comprise a carbonate compound such as calcium carbonate and in other embodiments there is no carbonate compound.

The stone dust particles are prepared by crushing or other comminution steps as would be appreciated by the skilled addressee. The fine particles of dust that result are light in colour, contain no more than 3% by mass of free silica and have diameters within the “Guidelines for Coal Dust Explosion, Prevention and Suppression”. There are known suppliers of stone dust for dusting processes across the world.

The stone dust particles for use in the invention are treated with a cationic and/or zwitterionic surfactant to modify their surface. The stone dust particles can be treated prior to supply to the coal mine or they can be treated once they are received for use in the mine The treatment steps are described in more detail below.

In order to determine the most appropriate surfactant for use, the surface chemistry of the stone dust particle can be deduced. This can be done using experimental techniques, or it may be known to the skilled addressee based on past experience. Omya Australia Pty Limited is the major supplier of stone dust to Australian mines Omya describe their product as being naturally ground calcium carbonate which usually consists of calcite, CaCO₃.

Once the surface chemistry is understood, the surface charge of the stone dust particles can be determined using literature sources. Alternatively, the surface charge present on the stone dust particles intended for use can be determined experimentally using, for example, negatively charged or positively charged dyes independently of deducing the surface chemistry.

In order to provide dust in which most of the particles exhibit a negative charge, the stone dust particles can be mixed with carbonate particles (which are the most desirable stone dust particles as described above). However, it has now been found that most stone dust for use in dusting coal mines exhibits a negative charge.

A negatively charged stone dust particle will readily react with a positively charged surfactant. Accordingly, cationic surfactants are appropriate for use in treating such stone dust particles. Zwitterionic surfactants are also able to treat negatively charged particles since they are capable of exhibiting a formal positive charge or a net positive charge when in proximity to a negative charge.

If the stone dust particles intended for use in the dusting process are found to have a positive surface charge and it is inappropriate to dilute the positively charged stone dust particles with negatively charged carbonate particles, a cationic surfactant will not be appropriate for use. Under these circumstances, a zwitterionic surfactant would be more appropriate. A zwitterionic surfactant is able to treat positively charged particles since the surfactant is capable of exhibiting a formal negative charge or a net negative charge when in proximity to a positive charge.

The inherent polaris ability of the zwitterionic surfactant makes it a particularly advantageous treatment agent for use in the invention. The overall surface charge on the stone dust particle does not need to be determined if the zwitterionic surfactant is selected, as it adsorbs to either a positive or a negative surface by adopting the net opposite charge to the stone dust particle.

In order to adsorb the surfactant to the surface of the stone dust particles, the stone dust particles are contacted with a liquid comprising or consisting of the surfactant. The surfactant itself may be provided as a liquid or it may be dissolved in a solvent to provide the solution. The stone dust particles can come into contact with the liquid surfactant or solution comprising the surfactant in any way. In some embodiments, a solution comprising the surfactant is prepared prior to bringing it into contact with the stone dust particles. For example, the solution comprising surfactant could be trickled through a packed bed or a heap of the stone dust particles. Alternatively, the stone dust particles could be mixed with the liquid surfactant or prepared solution comprising surfactant in a mixing vessel. Preferably the mixing is undertaken to ensure all of the particles come into contact with the surfactant. The stone dust mixed into the liquid surfactant or solution comprising surfactant forms a slurry.

Alternatively, the stone dust particles can be dispersed in a liquid to form a slurry and the surfactant, or a formulation or composition comprising the surfactant, can be added to the slurry. Alternatively, the formulation or composition comprising the surfactant can be added to the slurry immediately before application to the coal mine surfaces, for example, by dosing the formulation or composition into the applicator of an apparatus used to apply the slurry. This is described in more detail below.

In either case, where stone dust particles are mixed with a liquid to form a slurry, preferably at least 0.5 litres of liquid, more preferably about 1 litre of liquid is provided for every kilo of stone dust. In a preferred embodiment, the liquid is water. The liquid or water can act as a solvent for the surfactant or a mixture of surfactant components.

Commercial surfactants are generally supplied as aqueous solutions with varying percentages of active cationic or zwitterionic content. Reference to surfactant in this specification should be understood to mean active surfactant except when example formulations are given. In these examples the weight percentage of the commercial material is stated together with the active surfactant concentration in the commercial material.

The amount of formulation or composition comprising the surfactant brought into contact with the stone dust particles will depend upon the amount of stone dust present. Preferably, surfactant is added so that the resultant slurry comprises active surfactant in a range of from about 0.005 wt % to 2.5 wt % (as a percentage of the weight of stone dust particles used) more preferably about 0.05 wt % to about 1 wt %, most preferably about 0.1 wt % to about 0.4 wt %.

There may be more than a monolayer of surfactant adsorbed onto the stone dust particle surface. For example, it is possible that some of the particles have multi-layers of adsorbed surfactant forming lamellar coatings. Excess surfactant may form micelles in solution, which are not believed to have an adverse effect on the application of the stone dust particles.

Suitable cationic surfactants for use include cetyl trimethyl ammonium bromide (CTAB) or cetyl trimethyl ammonium chloride (CTAC), alkyl pyridinium chlorides, benzalkonium chlorides, twin chain QACs and long-chain tallow cationics. Any combinations of these cationic surfactants could also be used.

Suitable zwitterionic surfactants include cocoamine oxide, cocamidopropyl betaine, alkyl betaines, alkylaminopropioic acids, alkyliminodipropionic acids, alkylimidazoline carboxylates, sulphobetaines or combinations thereof.

It has been found advantageous to mix cationic surfactant with zwitterionic surfactant. Preferably, the blend comprises at least 60% of the zwitterionic surfactant (as a percentage of the total surfactant in solution), more preferably at least 65%. In some embodiments, up to 70-75% of the blend is zwitterionic surfactant. Preferably, the viscosity of the blend is in the range from about 100-1000 cP, more preferably 200-500 cP, to allow formulation to be dosed & mixed into the slurry.

The surfactant (blend or otherwise) should be selected to provide a slurry that can flow. In other words, the slurry should not be too viscous for the slurry application equipment and processes used to apply it. If the slurry is too viscous, it will require more water, which will mean the application process will take longer to apply the coating and there is more water to evaporate from the applied coating.

At least some of the treated or modified stone dust particles have a layer of surfactant covering the outside surface which changes the surface chemistry of the particle. Preferably, 100% of the stone dust particles treated are modified by the applied surfactant. However, in some embodiments, the treatment step may only modify a portion, not all of the particles. In other embodiments, stone dust particles treated with the cationic and/or zwitterionic surfactant are mixed with untreated particles to provide a treated/untreated mixture. For example, 150 kg of treated stone dust could be mixed with 50 kg of untreated stone dust before the dusting process. Thus, less than 100% of the particles can be treated provided the resultant coating applied to the coal mine surface remains dispersible when agitated. Preferably, at least 75%, more preferably at least 85% of the particles applied to the surfaces of the coal mine are treated.

The surfactant adsorbs onto the stone dust particles surface with the hydrophobic tail portion of the surfactant oriented away from the surface. Effectively, the surfactant provides a monolayer over the surface of the stone dust particle that inhibits interaction between adjacent particles. The ionisable or polar portion of the surfactant can interact with the chemical groups present on the surface of the stone dust particle through van der Waal or ionic interaction.

In another embodiment, the surfactant covalently bonds with the surface functional groups exposed on the stone dust particle surface forming a self-assembled monolayer over the surface. The resulting coal mine dusting agent is chemically equivalent to an agent having a surfactant attached thereto by van der Waals or ionic forces.

Once treated, the stone dust particles can be applied as a wet slurry to surfaces in the coal mine. Alternatively, the wet slurry can be dried to provide dry, treated stone dust particles. The dry, treated stone dust particles can be supplied as a coal mine dusting agent. The coal mine dusting agent can be applied to the coal mine surfaces as a dry powder. Clearly, this method of application suffers the disadvantages described above, including the requirement to shut down the mine during application. However, it may be a preferred means of application of stone dust particles in some situations. Once applied, the treated stone dust particles are thought to be superior to applied untreated stone dust particles, because the treated stone dust has a reduced propensity to absorb water, e.g. in the form of condensation, when on the coal mine walls. This means that caking of the applied coating could be inhibited over time.

Alternatively, the dry, treated dusting agent can be mixed with a liquid such as water to regenerate the wet slurry. The slurry can then be applied to the coal mine surfaces using a wet method of application. The wet application method is known to the skilled addressee. The slurry is usually applied using an apparatus which sprays the wet slurry via an applicator having a spray nozzle.

Optionally, the slurry is combined with a foaming agent in order to apply the stone dust particles as a foam. The foam dries on the walls of the coal mine to leave behind a friable coating that can be more effective than the coatings applied using dry or wet (non-foaming) methods. It is thought that the foam allows for rapid moisture evaporation once applied. Initial tests have also revealed that the foam generation provides a lower varying difference in particle distribution compared to dry dusted samples.

The foaming agent can be combined with the slurry as the stone dust particles are applied to the mine surfaces. Alternatively, the cationic or zwitterionic surfactant can be the foaming agent. However, cationic surfactants are not usually good foamers, so it will typically be the zwitterionic surfactant that is the foaming agent.

The slurry can be sprayed to form a coating having a thickness in the range of from about 5 to 20 mm.

If the slurry is applied wet (foamed or not), the flash point of the formulation and/or the resultant slurry should be above about 60° C., more preferably above about 80° C. In preferred embodiments, the solvent used to disperse the stone dust particles and to dissolve the surfactant is water or other dilute aqueous media, so the formulation and/or slurry does not have a flashpoint.

The apparatus used to apply the foamed slurry comprises a mixing tank in which the stone dust particles can be mixed with a solvent to form a slurry. A mixing paddle can be used to form the slurry. Preferably, the tank is enclosed to prevent contamination of the slurry from particles naturally present in the mine, for example, roof flake and other foreign material. However, contamination can still be a problem when the stone dust particles and/or formulation comprising surfactant is added to the tank. Accordingly, the tank can include a gravitational suction filtration system to prevent the contaminants from blocking the applicator nozzle used to apply the slurry as a foam.

The apparatus has an applicator connected to the mixing tank by, e.g. a hose or a discharge line, via which the slurry can be delivered for application. Preferably, the applicator comprises an aerator or a series of aerators for foaming the slurry as it is applied. The aerator(s) can be standard venturi foam fire fighting nozzles or a vee jet nozzle to help entrain air into the slurry mix to aid in foam generation. Alternatively, a ¼″ compressed air line can be installed to the outlet of the slurry pump and an inline mixer provided to assist in the entraining of the air to create the foam. The air line valve can deliver between about 50 to 250 litres of air per minute into the pump line.

As described above, the cationic and/or zwitterionic surfactant can be added to the mixing tank to treat the particles. Alternatively, where the surfactant is also a foaming agent, the surfactant can be added during application in order to provide foam comprising treated stone dust particles immediately before application to the coal mine surfaces. For example, as the slurry is pumped, the surfactant additive can be added to the slurry pump inlet. Air can be added at the pump outlet and the aerated mix will continue along the discharge line until it exits through the series of vee jet nozzles or a single larger vee jet nozzle. This system may be required for the application of foam, since the formation of foam in the mixing tank will present problems. In order to promote foam formation, the applicator could comprise one or more baffles to mix the slurry before application.

With the generation of foam comes a range of other operational issues that require consideration. The flow rate of the product, correct chemical dosing quantities, flow rate of air, air pressure and line pressure all play equally important roles in suitable foam generation. Preferably, the product slurry is pumped onto the surfaces at about 40 to 80 litres per minute, more preferably about 60 litres per minute. The line pressure can vary between about 50 and about 70 psi.

Embodiments of the invention will now be described with reference to the following non-limiting examples.

### EXAMPLES

### Example 1

### Laboratory Replication of Mine Process

In order to replicate the dusting process in a mine the following steps were undertaken in the laboratory:
1. A water/stone dust particle slurry was produced using 30 grams stone dust and 10 grams water.
2. The wet stone slurry was applied onto a porous tile, to replicate a porous coal wall.
3. The slurry was dried in an oven, to cause the water to evaporate.
4. The tile was cooled and held vertically. The tile was tapped to replicate a seismic event.
5. The degree and texture of the stone dust dislodged was evaluated.

The stone dust particles dislodged from the tile as a sheet or in lumps. This was considered a reasonable replication of the reported real-world mine problem when using a simple stone dust particles plus water slurry.

### Example 2

### Determining the Surface Charge of Stone Dust Particles

Stone dust particles were mixed in potable water and exhibited a pH of 7.5. Stone dust particles were next mixed with acid water. The calcium carbonate content of the stone dust neutralized the acidity with a final pH of pH 7.5. Hence, the calcium carbonate exhibits pH buffering to pH 7.5

A positively charged dye absorbed onto the dust particles surface, indicating that the stone dust particles being evaluated exhibited a negative surface charge at the buffered pH of 7.5.

### Example 3

### Preparation of a Formulation Comprising Surfactant

### Example 3.1

### Formulation A

Benzalkonium chloride (50%), cetyl trimethyl ammonium chloride (50%) (CTAC) and methyl-bis(tallowamidoethyl)-hydroxyethylammonium methosulphate (90%) were mixed with water at low speed to avoid aeration to provide the following formulation having about 40.2% active surfactant content:

| | |
|---|---|
| 29.0 wt % | Water |
| 47.4 wt % | Benzalkonium chloride (50%) |
| 11.8 wt % | Cetyl trimethyl ammonium chloride (50%) |
| 11.8 wt % | Methyl-bis(tallowamidoethyl)-hydroxyethylammonium |
| | methosulphate (90%) |

NB The (%) refers to the active surfactant concentration in the commercial raw material. Resulting Formulation A was an opaque emulsion having a viscosity in the range of from about 200 to about 300 centipoise (cP)

### Example 3.2

### Formulation B

Zwitterionic surfactants were mixed with water at a low speed to avoid aeration. A high foaming blend consisting of about 30% active zwitterionic surfactant was produced comprising:

| | |
|---|---|
| 50 wt % | Cocoamine oxide (30%) |
| 50 wt % | Cocamidopropyl betaine (30%) |

The formulation was a stable, clear liquid of low viscosity.

### Example 3.3

### Formulation C

3 parts of Formulation B was mixed with 1 part of Formulation A to provide the following blend with about 32.4% active surfactant content:

| | |
|---|---|
| 37.4 wt % | Cocoamine oxide (30%) |
| 37.4 wt % | Cocamidopropyl betaine (30%) |
| 11.8 wt % | Benzalkonium chloride (50%) |
| 7.6 wt % | Water |
| 2.9 wt % | Cetyl trimethyl ammonium chloride (50%) |
| 2.9 wt % | Methyl-bis(tallowamidoethyl)-hydroxyethylammonium |
| | methosulphate (90%) |

Formulation C provides zwitterionic surfactant to generate the foam, together with the more active surface-treatment properties of the cationic surfactants. Formulation C was a stable, clear liquid having a viscosity in the range of about 200 to 500 cP. SG was measured as 1.0. The pH was in the range of from about 6 to about 8.

### Example 4

### Dusting

A fire gallery constructed of fire brick and a rolled iron roof was used. The gallery was approximately 25 metres long, 3 metres wide and 2 metres high at the top of the rolled roof section. The floor was made from solid concrete and sloped in a cross gradient for drainage. The gallery also contained a mock conveyor structure as well as a universal beam frame half-way along the gallery. This frame was used for setting props and other rescue equipment.

The full scale testing required mobilisation of actual underground wet dusting equipment. A hydraulically driven QDS wet dusting attachment was set up outside the fire gallery. It was necessary to provide an external source of hydraulic supply as with all QDS equipment the hydraulic supply comes from the LHD.

A 200 litre capacity hydraulic power pack providing 60 litres of oil per minute at 2100 psi substituted for the LHD and a 75 kw diesel generator with a DOL motor starting outlet powered this unit.

Six 250 kg bulk slurry stone dust spraying tests were conducted.

### Example 4.1

### Test 1—Control

The intention of the first of the spraying trials was to prove that the overall equipment set up was adequate to complete the task.

250 litres of water was added to a mixing tank and the mixing paddle was engaged. Using the onboard 1 tonne Hiab crane, a 250 kg bulk bag of stone dust particles was lifted over the top of the mixing tank. A custom manufactured extension bag cutter opened the bottom of the bag and the contents (stone dust particles) emptied into the mixing tank.

The slurry product was pumped through two 20 metre, 25 mm fire resistant anti-static air/water hoses at 50 litres per minute. The roof and sides of the fire gallery were sprayed.

The equipment set up was successful. The mix was very wet and the slurry tended to wash and fall from the roof and sides under the force of gravity.

### Example 4.2

### Test 2

The procedure outlined in Example 1 was repeated except 185 litres of water was added to the mixing tank and 5 litres of Formulation A was added directly to the mixing tank to give 2% of Formulation A per batch of stone dust particles comprising about 0.8% active surfactant.

Spraying was halted because the mixing paddle was running in a ball of foam which prevented the paddle from agitating the contents of the mixing tank. This resulted in water/stone dust separation causing the pump inlet to become blocked.

### Example 4.3

### Test 3

The procedure outlined in Example 1 was repeated except 185 litres of water was added to the mixing tank and Formulation A was dosed into the mixing tank. A 240 volt diaphragm pump was set up to dose 2% of Formulation A per batch of stone dust particles.

Spraying continued with a noted reduction in rebound and there was a lack of foaming at the nozzle of the apparatus.

### Example 4.4

### Test 4

The same procedure as for Example 4.3 was undertaken, but a standard venturi foam fire fighting nozzle was applied to the applicator of the apparatus to help entrain air into the slurry mix to aid in foam generation.

Spraying continued with noted improvement in the reduction in rebound and the final surface finish was a foam blanket up to 5 mm thick.

### Example 4.5

### Test 5

The same procedure as for Example 4.3 was undertaken, but a ¼″ compressed air line was installed to the outlet of the slurry pump. An inline mixer was added to assist in the entraining of the air to create the foam. The air line valve was opened delivering 200 litres per minute into the pump line. A stainless steel vee jet nozzle was also fitted to the applicator of the apparatus.

Spraying continued with noted improvement in the reduction in rebound and the final surface finish was a thick foam up to 20 mm thick.

### Example 4.6

### Test 6

The same procedure as for Example 4.5 was undertaken, but the 240 volt diaphragm pump was set up to dose 1% of Formulation A per batch of stone dust particles to give an active surfactant concentration of about 0.4% per batch of stone dust particles.

Spraying continued with noted improvement in the reduction in rebound and the final surface finish was a thick foam up to 15 to 20 mm thick.

The results from Examples 4.5 and 4.6

Samples were taken from the foam produced by Examples 5 and 6.

The method of sampling utilised a pan and soft bristle brush. The stone dust particles came freely came away from the walls with a single pass of the brush.

A general note observed was the variance in the moisture results due to the type of wall structure. The side walls are manufactured from steel Armco sheeting and the rear walls are manufactured from rock block.

It was also noted that the more foamed the finished dried surface was, the easier it was to sample and the test results indicate that on some surfaces the particle distribution was +/−1% variation on the original dry dust sample. The variation in results is attributed to the different materials from which the surfaces were formed.

Test 5

| Sample | Moisture | F250 micron | F75 micron |
|---|---|---|---|
| Bag dry sample | 0.0 | 95.6 | 60.2 |
| Side wall lhs | 0.0 | 95.0 | 54.4 |
| Side wall rhs | 0.0 | 95.8 | 58.2 |
| Rear wall lhs | 0.40 | 94.7 | 56.7 |
| Rear wall rhs | 0.82 | 95.2 | 54.9 |

Test 6

| Sample | Moisture | F250 micron | F75 micron |
|---|---|---|---|
| Bag dry sample | 0.25 | 95.9 | 59.5 |
| Front floor | 0.18 | 95.7 | 60.1 |
| Rear floor | 1.8 | 96.7 | 60.7 |
| Side wall rhs | 1.1 | 96.3 | 59.8 |
| Side wall rhs | 1.6 | 96.7 | 61.8 |

### Example 5

### Mine Testing

As foaming was found to be desirable, a high foaming surfactant mix that was stable in presence of cationic surfactants of Formulation A was made i.e. Formulation B. Some initial trials were done using various blends of Formulation A+B to obtain a more stable degree of foaming. The optimum level of foaming was found to be formed a blend of 3 parts Formulation B and 1 part Formulation A, i.e. Formulation C.

The method of the invention was tested in a coal mine. The experimental tunnel consisted of a steel pipe of 200 metres long and 2.5 metres in diameter, closed at one end. At the closed end, the tunnel was equipped to form a zone of exposable methane in air. A plastic membrane was placed across the tunnel to form a volume of 35 to 50 m³ (7.5 to 10 m long) inside which a mixture of air and methane was formed.

Coal dust can be distributed in a number of different ways in the remainder of the tunnel so that on ignition of the methane/air zone the coal dust was dispersed and ignited to form a coal dust explosion. The distribution of the coal dust, the intended dust concentration, the proportion of stone dust added to the coal dust and the initial methane concentration in the ignition zone could all be varied depending upon the requirements of the particular test programme.

For this test programme, it was decided the best method of comparing the dispersal characteristics of different types of stone dusting was to subject a series of trays containing the different types of stone dust particles (treated and untreated) to a methane only explosion.

To test the dispersal characteristics of a dust, a tray was loaded with that dust and subjected to the passage of an explosion wave. Untreated, dry stone dust was loaded without being compacted at all. Any excess dust above the level of the tray lip was leveled off.

In the case of the wet and foam stone dust trays, the trays were prepared prior to the testing, so that the stone dust particles had time to dry out to the final consistency. The stone dust particles were treated using 1% Formulation C, based on wt of stone dust. The level of dust was no higher than the top lip of the trays.

Before placing the trays in the tunnel, the total mass of each tray was weighed and recorded for comparison against the post-explosion weight.

Once the trays were in position, the preparation of the gas zone at the closed end of the tunnel commenced and the explosion was ignited a few minutes later. The methane concentration could be varied to alter the strength of the explosion required. The effect of the explosion was to generate a pressure wave that traveled the length of the tunnel that would lift dust from the trays and propel it out of the tunnel. There was some tidal airflow in the mouth of the tunnel after the passage of the initial explosion wave, but this did not appear to have disturbed significant quantities of dust.

The trays were then removed and reweighed so that the losses from each could be recorded. By placing different types of stone dust on each of the trays the comparative losses were considered to be representative of the dispersal characteristics of each dust in the event of a coal dust explosion.

The results from Example 5

The dispersion results of the treated stone dust particles applied as a foam and dry stone dust particles are shown in the Table 1 below. The Test Numbers referred to are for reference purposes only.

TABLE 1
Dispersion testing results

| Test | | Foam Dust | | Dry Dust | | Delta*** | Velocity |
|---|---|---|---|---|---|---|---|
| No | CH4 % | Position | Loss (g) | Posn | Loss (g) | (g) | (m/s) |
| 6* | 9% | NS | 3218 | FS | 3462 | | 88 |
| 10 | 7.5% | NS | 2855 | FS | 1754 | 1101 | 94 |
| 11 | 7.5% | FS | 1485 | NS | 1755 | −270 | 52 |
| 12 | 7.5% | NS | 3035 | FS | 2075 | 960 | 85 |
| 13 | 7.5% | FS | 2300 | NS | 1810 | 490 | 76 |
| 14 | 7.5% | FS | 3315 | NS | 1845 | 1470 | ND |
| 17** | 7.5% | FS | 1420 | NS | 820 | | 96 |

| At 7.5% (for Test No.s 10, 11, 12, 13 & 14 only) | | | | |
|---|---|---|---|---|
| Average | 2598 | 1848 | 750 | 77 |
| StDev | 724 | 133 | 670 | 18.1 |
| StDev/Ave [symbol] | 28% | 7% | 89% | 24% |
| | (g/m2) | (g/m2) | (g/m2) | |
| Average | 8660 | 6159 | 2501 | |
| StDev | 2414 | 442 | 2232 | |

Notes
Test Comment
6* 9% methane in ignition zone
17** With a layer of coal dust on top of stone dust
***Delta = (Foam dust dispersal − dry stone dust dispersal) [symbol]
indicates data missing or illegible when filed

In five of the seven tests, the dispersal of the treated stone dust particles applied as a foam was greater than the dry stone dust particle dispersal. In four of the five tests conducted with a methane concentration in the ignition zone of 7.5%, the dispersal of foam stone dust particles was greater than the dry stone dust particles. In these same tests, the average dispersion of foam stone dust particles was 8660 gram/m², compared with an average for dry stone dust particles of 6501 gram/m². This represents an increase of 40%. From this it would appear that foam stone dusting provides better dispersal characteristics in an explosion than dry stone dusting.

Samples taken after the surface trials showed that the particle size of the dried stone dust particles applied according to the present invention were not significantly different to that of the traditionally applied dry stone dust particles. Similarly, during the underground trials, samples of dried stone dust particles applied according to the present invention were similar in particle size distribution with that of conventional dry stone dust samples collected from the mine at the same time.

This supports the conclusion that the size distribution of the dried, treated stone dust particles was not significantly different to that of traditionally applied dry stone dust under comparable conditions.

Those skilled in the art will appreciate that the invention described herein is susceptible to variations and modifications other than those specifically described. It is to be understood that the invention includes all such variations and modifications which fall within its spirit and scope.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of dusting coal mine surfaces, the method comprising applying stone dust particles treated with a cationic and/or zwitterionic surfactant to surfaces in the coal mine.

2. The method according to claim 1, wherein the stone dust particles are treated by mixing with a liquid comprising or consisting of the cationic and/or zwitterionic surfactant.

3. The method according to claim 2 wherein the liquid is in the form of an aqueous solution comprising the cationic and/or zwitterionic surfactant

4. The method according to claim 2, wherein the mixture of stone dust particles and the solution comprising the cationic and/or zwitterionic surfactant forms a slurry and the stone dust particles are applied as the slurry.

5. The method according to claim 4, wherein the slurry includes a foaming agent and the slurry is aerated during application to form a foam.

6. The method according to claim 5, wherein the cationic and/or the zwitterionic surfactant is the foaming agent.

7. The method according to claim 2, wherein the mixture of stone dust particles and the liquid comprising or consisting of the cationic and/or zwitterionic surfactant forms a slurry and the method further includes the step of drying the slurry so that the stone dust particles are applied dry.

8. A liquid formulation when used to treat stone dust particles applied to coal mine surfaces, the formulation comprising or consisting of a cationic and/or zwitterionic surfactant.

9. A formulation according to claim 8 comprising a blend of cationic and zwitterionic surfactant, wherein the zwitterionic surfactant comprises at least 60%, more preferably at least 65% of the blend.

10. A formulation according to claim 8, wherein the formulation comprises a cationic surfactant selected from cetyl trimethyl ammonium bromide (CTAB), cetyl trimethyl ammonium chloride (CTAC), alkyl pyridinium chlorides, benzalkonium chlorides, twin chain QACs, long-chain tallow cationics and any combination thereof.

11. A formulation according to claim 8, wherein the formulation comprises a zwitterionic surfactant selected from cocoamine oxide, cocamidopropyl betaine, alkyl betaines, alkylaminopropioic acids, alkyliminodipropionic acids, alkylimidazoline carboxylates, sulphobetaines or combinations thereof and any combination thereof.

12. A formulation according to claim 11 comprising cocoamine oxide and cocamidopropyl betaine.

13. A formulation according to claim 8 which is in the form of an aqueous solution.

14. A coal mine dusting agent comprising stone dust particles treated with a cationic and/or zwitterionic surfactant.

15. A coal mine dusting agent according to claim 14 in the form of a slurry.

16. A coal mine dusting agent according to claim 14, wherein a zwitterionic surfactant is present, the zwitterionic surfactant comprising cocoamine oxide and/or cocamidopropyl betaine.

17. An apparatus when used to apply a foamed slurry comprising stone dust to the surfaces of a coal mine, the apparatus comprising:
a mixing vessel in which stone dust particles are mixed with a liquid to form a slurry; and
an applicator connected to said mixing vessel for application of the slurry to the coal mine surfaces, said applicator comprising an aerator for foaming the slurry as it is applied;
wherein said stone dust particles are treated with a cationic and/or zwitterionic surfactant prior to application to the coal mine surfaces.
